(19) United States
(12) Patent Application Publication
(10) Pub. No.: US 2008/0138672 A1
(43) Pub. Date: Jun. 12, 2008

(54) Fuel cell and associated method

(75) Inventors: Ganapathisubbu Sethuvenkatraman, Bangalore (IN); Mahendra Madhukar Patil, Bangalore (IN); Ravichandra Srinivasa Jupudi, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/636,029

(22) Filed: Dec. 8, 2006

(51) Int. Cl. H01M 8/02

(52) U.S. Cl. 429/13; 429/34

(57) ABSTRACT

An apparatus is provided that includes a housing having an interior surface defining a volume, and an air inlet and an air outlet through which the volume is in fluid communication with the ambient environment. The apparatus includes a plurality of electrodes including at least one emitter electrode and at least one attracting electrode, and the plurality of electrodes are in fluid communication with the air inlet. The apparatus can include a potential generating device capable of applying a potential across the plurality of electrodes sufficient to cause a corona current between the at least one emitter electrode and the at least one attracting electrode. The corona current imparts momentum to surrounding gaseous atoms and molecules. The momentum results in a net fluid flow towards and through the one air inlet. And, the apparatus can still further include a fuel cell disposed within the volume and configured to receive the net fluid flow.

### BACKGROUND

1. Technical Field

Some embodiments of the invention may relate to a fuel cell. Some embodiments of the invention may relate to a method associated with a fuel cell.

2. Discussion of Related Art

Fuel cells that react oxygen with hydrogen rely on air for supplying oxygen to the cell. One way of generating energy from such cells is to arrange them in an array. Such arrays may require a greater oxygen supply than any one element of the array. Thus, performance depends on oxygen availability. Molecular oxygen diffusion may not be sufficient to satisfy the oxygen demand at the cathode. This problem has been addressed by providing a mechanical driving mechanism, such as a fan, to force airflow to the cells. Unfortunately, fans consume electrical energy. Fans may have a negative impact on the efficiency of the system. Additionally, fans tend to be noisy and may cause undesirable vibrations.

It may be desirable to cause an air to flow through a fuel cell using a structure that may be different than those currently used. Furthermore, it may be desirable to z have a different method for providing airflow to one or more fuel cells.

### BRIEF DESCRIPTION

The invention includes embodiments that may relate to an air moving apparatus. The apparatus includes a housing having an interior surface defining a volume, and an air inlet and an air outlet through which the volume is in fluid communication with the ambient environment. The apparatus includes a plurality of electrodes, the plurality including at least one emitter electrode and at least one attracting electrode. The plurality of electrodes is in fluid communication with the air inlet. The apparatus can include a potential generating device capable of applying a potential across the plurality of electrodes sufficient to cause a corona current between the at least one emitter electrode and the at least one attracting electrode. The corona current imparts momentum to surrounding gaseous atoms and molecules. The momentum results in a net fluid flow towards and through the one air inlet and to at least one of the electrodes.

The invention also includes embodiments that may relate to a method. The method can include applying a potential difference between at least one emitter electrode and at least one attracting electrode sufficient to cause a corona current between the at least one emitter electrode and the at least one attracting electrode and to impart momentum from the corona current to surrounding gaseous atoms and molecules, wherein the momentum results in a net fluid flow towards and through an air inlet and further to a fuel cell in fluid communication with the air inlet. The method may further include receiving the net fluid flow at the fuel cell, and the fuel cell using one or more reagent gases in the net fluid flow.

The invention may include embodiments that relate to an apparatus. The apparatus can include a containment means capable of receiving and venting a gas flow, and capable of containing one or more of the apparatus's component parts. The apparatus can further include a corona discharge means capable of contacting a gas flow and imparting charge thereto. The apparatus can still further include a corona current collection means capable of contacting a gas flow and collecting excess charge therefrom. Still further, the apparatus can include a potential generating means capable of applying a potential between the corona discharge means and the corona current collection means sufficient to cause a corona current, wherein the corona current is capable of imparting momentum to surrounding gaseous atoms and molecules, wherein the momentum results in a net fluid flow through the containment means. And still further, the apparatus can include a fuel cell means capable of receiving at least one vented gas stream from the containment means.

### BRIEF DESCRIPTION OF THE DRAWING FIGURES

FIG. 1 is a uniform square cross section attracting electrode configuration of an electrostatic air moving system;

FIG. 2 is a variable radius circular cross section configuration of attracting electrode of an electrostatic air moving system;

FIG. 3 is a flat plate attracting electrode configuration of an electrostatic air moving system;

FIG. 4 is a contoured profile plate attracting electrode configuration of an electrostatic air moving system;

FIG. 5(a) is a plan-view drawing parallel to the central axes of three helical emitter electrodes wired in parallel and spaced apart from four parallel plate attracting electrodes;

FIG. 5(b) is a frontal-view drawing of the system shown in 5(a) where the view is perpendicular to the central axes of the three helical emitter electrodes, and the emitters are positioned in front of the attracting electrodes;

FIG. 5(c) is a plan-view drawing parallel to the central axes of three cylindrical emitter electrodes wired in parallel and spaced apart from four parallel plate attracting electrodes;

FIG. 5(d) is a frontal-view drawing of the system shown in 5(c) where the view is perpendicular to the central axes of the three cylindrical emitter electrodes, and the emitters are positioned in front of the attracting electrodes;

FIG. 5(e) is a plan-view drawing perpendicular to the central axes of three conical emitter electrodes wired in parallel and spaced apart from four parallel plate attracting electrodes;

FIG. 5(f) is a frontal-view drawing of the system shown in 5(e) where the view is parallel to the central axes of the three conical emitter electrodes, and the emitters are positioned in front of the attracting electrodes;

FIG. 6(a) is a drawing showing an axial cross section view of two parallel contoured plate attracting electrodes having a conical emitter electrode disposed near one end in an axial relation;

FIG. 6(b) is a drawing showing an axial cross section view of a tubular attracting electrode having a circular cross section and having a conical emitter electrode disposed near one end in a coaxial relation;

FIG. 6(c) is a cut-away side view of a conical attracting electrode having a conical emitter electrode disposed near the wider open end of the attracting electrode;

FIG. 6(d) is an axial cross section view of a pair of parallel plate attracting electrodes having a conical emitter electrode disposed near one end in an axial relation;

FIG. 6(e) is an axial cross section view of a tubular attracting electrode having a square cross section and having a conical emitter electrode disposed near one end in a coaxial relation;

FIG. 6(f) is a cut-away side view of a conical attracting electrode having a variable radius and having a conical emitter electrode disposed near the wider open end of the attracting electrode;

FIG. 7 is a plot showing the relationship between air flow velocity and applied voltage;

FIG. 8(a) is a plot showing the relationship of air flow velocity and corona current;

FIG. 8(b) is a schematic drawing showing the placement of an ammeter in an example circuit comprising a single emitter and attracting electrode;

FIG. 9 is a schematic drawing showing a conical emitter electrode in combination with a parallel plate attracting electrode;

FIG. 10 is a schematic drawing showing a two-stage air moving device arranged in a serial relation;

FIG. 11 is a schematic drawing showing a two-stage air moving device arranged in a parallel relation;

FIG. 12 is a schematic of an electrostatic air moving device of the present invention showing the approximate positions where air samples are taken for measuring particulate content;

FIG. 13 is a generalized drawing showing an electrostatic air moving device pushing air into a fuel cell array at one end and the array venting the air stream at an opposing end;

FIG. 14 is a generalized drawing showing an electrostatic air moving device drawing air from a fuel cell array and the array taking in air at an opposing end;

FIG. 15 is a generalized drawing showing a plurality of electrostatic air moving devices arranged in parallel and pushing air into a fuel cell array, and the array venting the air stream at an opposing end; and

FIG. 16 is a generalized drawing showing a plurality of electrostatic air moving devices arranged in parallel and drawing air from a fuel cell array, and the array taking in air at an opposing end.

### DETAILED DESCRIPTION

The invention may include embodiments that relate to a fuel cell. Some embodiments of the invention may relate to a method associated with the fuel cell.

Approximating language, as used herein throughout the specification and claims, may be applied to modify any quantitative representation that could permissibly vary without resulting in a change in the basic function to which it is related. Accordingly, a value modified by a term such as “about” may not to be limited to the precise value specified, and may include values that differ from the specified value. In at least some instances, the approximating language may correspond to the precision of an instrument for measuring the value. Similarly, “free” may be used in combination with a term, and may include an insubstantial number, or trace amounts, while still being considered free of the modified term.

In one embodiment, an apparatus includes a housing and a plurality of electrodes. Suitable housings have an interior surface that defines a volume, and have at least one air inlet and at least one air outlet through with the volume can communicate with the ambient environment. The air outlet is in fluid communication with the air inlet. The electrodes are in fluid communication with the air inlet.

The contour, size and shape of the air inlet and air outlet allow for transferring air in and out of the housing. The housing may be box-like, triangular, or tubular. Body shapes comprising tubes can have any appropriate cross sectional shape such as square, round, hexagonal or polygonal. Suitable housings can be formed from one or more of ceramics, organic resins, metals or alloys, and natural materials such as wood or wood-based products. Suitable resins include polymeric materials and reinforced or composite materials. In one embodiment, the reinforced composite includes glass fiber or carbon fiber, and the matrix resin includes polyether imide, polycarbonate, or polyphenylene oxide. Suitable matrix resins are commercially available from, for example, GE Plastics, Inc. (Pittsfield, Mass.).

Some embodiments operate by charging and/or ionizing air gases in a high voltage electric field. Charged air gases disposed within the field are forced to migrate away from one electric pole and toward another. Thus, the field imparts momentum to the charged species. Such species may collide with un-charged, i.e. neutral, species thereby transferring a portion of their momentum to the uncharged species. This effect may result in a net flow of air through the air-moving device.

Suitable electrodes may include an emitter electrode and an attracting electrode. Such embodiments also include a device capable of applying a potential between the electrodes, and thus a potential between the emitter and attracting electrodes. Such voltage may be sufficient to result in a corona current between the electrodes. The corona current may be in a range of from about 0.01 milliamp (mA) to about 0.2 mA, from about 0.01 mA to about 0.05 mA, from about 0.05 mA to about 0.1 mA, from about 0.1 mA to about 0.15 mA, or from about 0.15 mA to about 0.2 mA. In one embodiment, the current may be greater than about 0.01 mA. In one embodiment, the current may be greater than about 0.2 mA. Here, as elsewhere in the specification and claims, ranges may be combined and/or interchanged.

A suitable emitting electrode may emit electrons during use. The electrons may be captured by air gas species, such as by diatomic or molecular oxygen. In another embodiment, the emitting electrode may produce ions by causing neutral species to decompose into a plurality of ionic species. Conversely, the attracting electrode may produce an electric field sufficient to attract the charged species. In one embodiment, the attracting electrode may accept excess charge from such charged species, thereby neutralizing the charged species. In another embodiment, the charged species neutralize by ion recombination rather than charge transfer to the attracting electrode. The air gas species tend to continue flowing past the attracting electrode and out through the air outlet as an effluent air stream. The air outlet may be coupled to one or more fuel cells that are capable of receiving the effluent stream, and using one or more reagent gases in the effluent stream (e.g. oxygen), and venting the unused balance of the effluent stream.

With reference to the Figs., suitable emitter electrodes may be cylindrical 512, azimuthally symmetric, helical 502, spherical, ellipsoidal, or conical 522. Furthermore, emitter electrodes of one geometry may be used in connection with emitter electrodes of another geometry. When more than one emitter electrode is used, they may be arranged in parallel. Suitable emitter electrodes may be made from or coated with, for example, one or more of copper, aluminum, ferrous alloys, gold, silver, platinum, or nickel. Suitable ferrous-based alloys may include HASTELLOY or INCONEL that are commercially available.

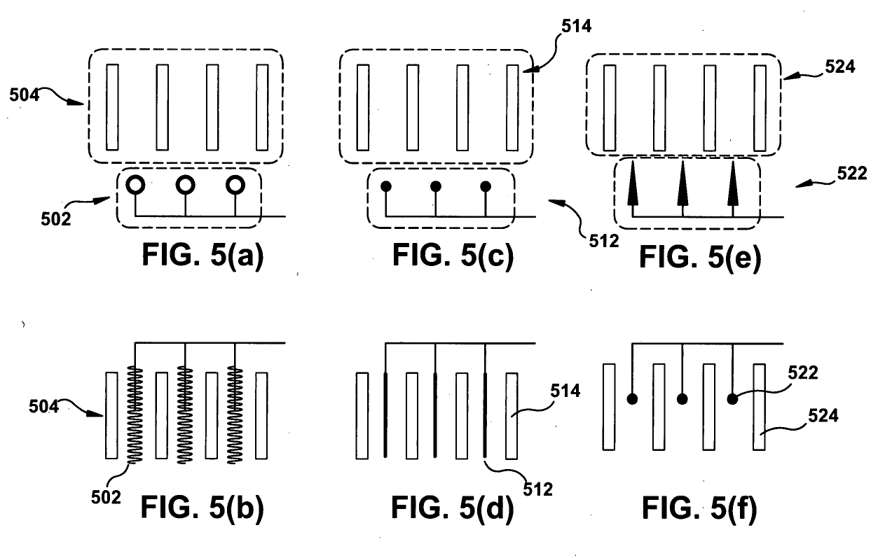

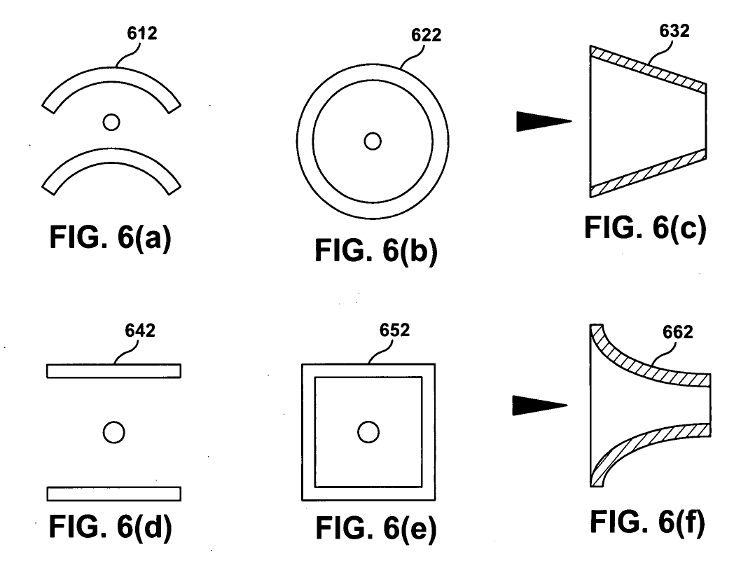

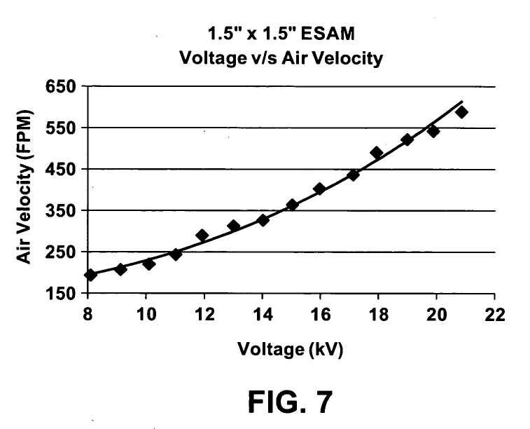

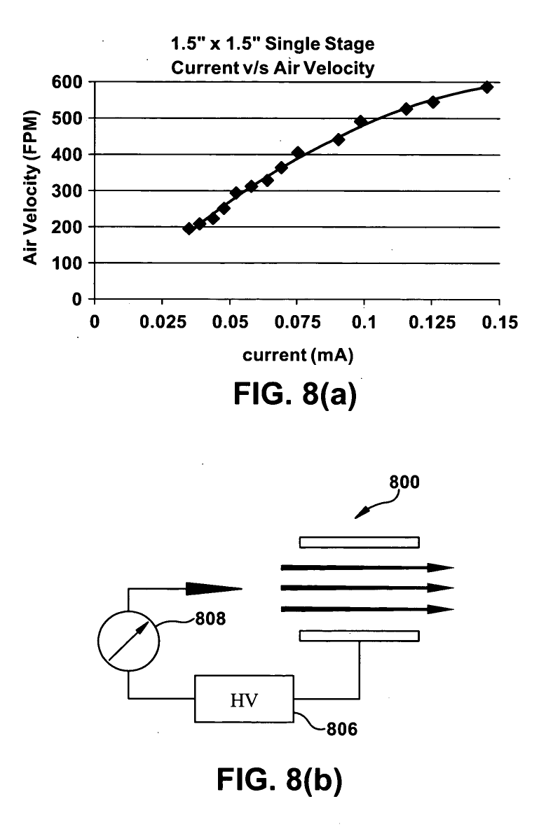

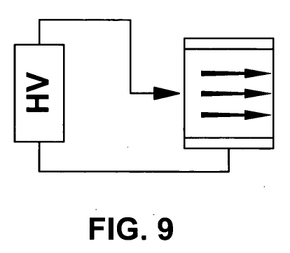

The emitter electrodes may be arranged in a pattern. For example, FIGS. 5(a) and 5(b) show a group of three helical emitter electrodes, wired in parallel, in relation to a set of four parallel plate attracting electrodes. FIG. 5(a) is a plan view down the axes of the three helical electrodes, while FIG. 5(b) is a frontal view having the helical electrodes in front of the attracting electrodes. FIGS. 5(c) and 5(d) show a similar arrangement of a set of three cylindrical wire emitter electrodes. And, FIGS. 5(e) and 5(f) show the same arrangement applied to a set of three conical spike emitter electrodes.

Attracting electrodes may have a defined geometry. Suitable attracting electrode geometries may be selected from one or more of parallel plates 304, 642; parallel contoured surfaces 404, 612; tubular with a circular cross section 622; tubular with a square cross section 104, 652; a cone having a linearly variable radius and opposing open ends 204, 622; and a cone having a non-linearly variable radius and opposing open ends 662. Furthermore, attracting electrodes of one geometry may be used in connection with attracting electrodes of another geometry. When more than one attracting electrode is used, they may be arranged either in series, in parallel or a portion may be arranged in series and another portion arranged in parallel. Additionally, attracting electrodes may be made from, for example, materials suitable for use as the emitting electrode.

The potential-generating device (e.g. 110, 210, 310) capable of applying a potential between the electrodes (i.e., potential means) may produce an output voltage that is greater than about 1 kiloVolt (kV). In one embodiment, the output may be in a range of from about 1 kV to about 10 kV, from about 10 to about 20 kV, from about 20 to about 30 kV, from about 30 to about 40 kV, or from about 40 to about 50 kV. The output voltage may be selected to be constant, variable, and/or programmable based on the intended end-use configuration and parameters. Additionally, the potential-generating device may draw power from the fuel cell, from an external source, such as grid power sources; or from both the fuel cell and from an external power source. When the potential-generating device draws on a plurality of power sources the potential-generating device may draw on the sources simultaneously or alternately.

Some embodiments may include a current measuring device 808 for measuring a corona current between the emitter electrode and the attracting electrode. Suitable current measuring devices can include, for example, an ammeter in electrical communication with the emitter electrode or the attracting electrode. The current measuring device may monitor air flow through some embodiments of the air moving device of the invention, inasmuch as corona current is relatable to air flow.

Some embodiments may control cell temperature by promoting heat transfer out of the cell. According to such embodiments, an air stream exits a fuel cell having an outgoing temperature that is higher than that of the incoming air stream. The air stream contacts the cell and absorbs excess heat contained therein. The air stream containing excess heat then flows out of the fuel cell thereby dissipating heat from the cell.

Some embodiments may remove particulate species suspended in the incoming air stream. For example, processes related to electrostatic precipitation may remove such particulate species. The particulate species is ionized in the electric field produced in the air moving device. The ionized particulate species, or some portion thereof, may then collide with the attracting electrode. At least a portion of the particulate species that collide with the attracting electrode deposit on the attracting electrode and are thus removed from the air gas stream. Therefore, the effluent air gas stream may have fewer particulate species than the incoming air gas stream. In one embodiment, the particulate reduction may be expressed as the amount of particles removed relative to the particulate count of the incoming air stream. The amount removed may be such that there are about 45 percent fewer particulates. In one embodiment, the amount may be in a range of from about 5 percent to about 10 percent, from about 10 percent to about 15 percent, from about 15 percent to about 25 percent, from about 25 percent to about 30 percent, from about 30 percent to about 40 percent, or from about 40 percent to about 45 percent, from about 45 percent to about 50 percent, from about 50 percent to about 60 percent, from about 60 percent to about 65 percent fewer particulates relative to the incoming air stream. The amount of particulate reduction may be based on the type, the charge, and the size of the particulate matter. Other factors may include the corona current, the spacing and configuration of the plurality of electrodes, the ambient conditions (such as humidity), and the like.

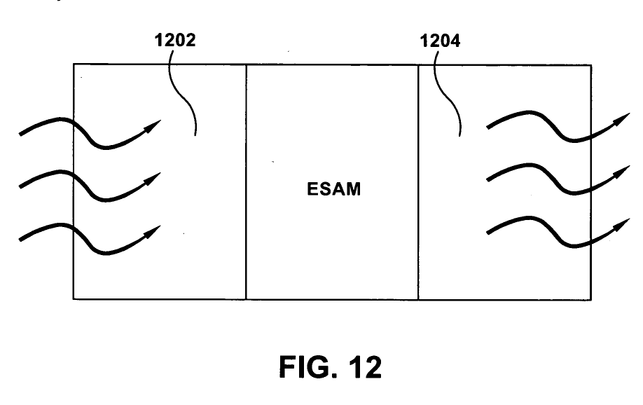

According to one embodiment, a gas stream is sampled at a position 1202 upstream from the electrostatic air moving device (ESAM), and sampled again at a position 1204 downstream from the ESAM. FIG. 12 shows, generally, where the upstream and downstream samples are taken. Representative data obtained from this embodiment is set forth in Table 1.

TABLE 1
Sample Data

| Particle Size | Upstream | Downstream | Removal |
|---|---|---|---|
| (micrometers) | Particle Count | Particle Count | Efficiency (%) |
| 0.3 | 972978 | 545758 | 0.44 |
| 0.5 | 62861 | 25697 | 0.59 |
| 1 | 8096 | 3047 | 0.62 |
| 3 | 798 | 291 | 0.64 |
| 5 | 373 | 125 | 0.66 |
| 10 | 20 | 17 | 0.15 |

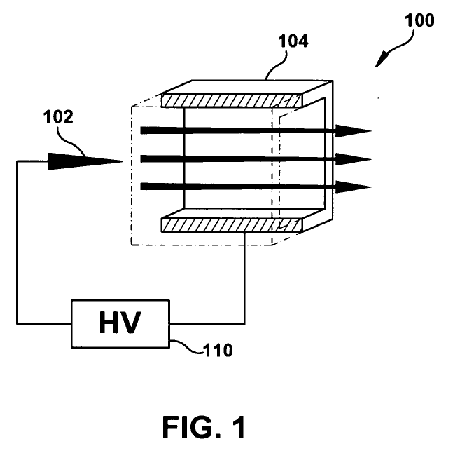

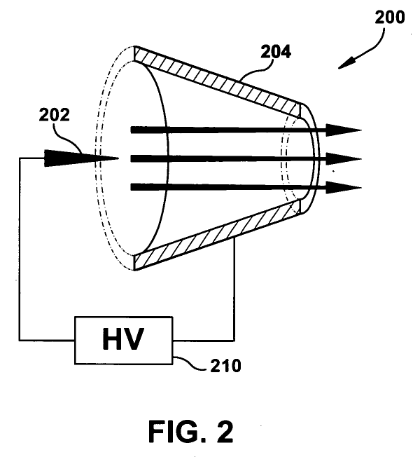

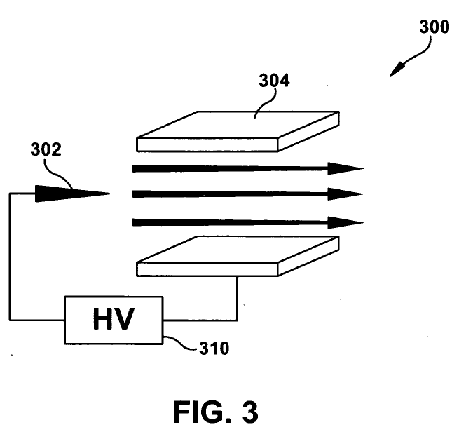

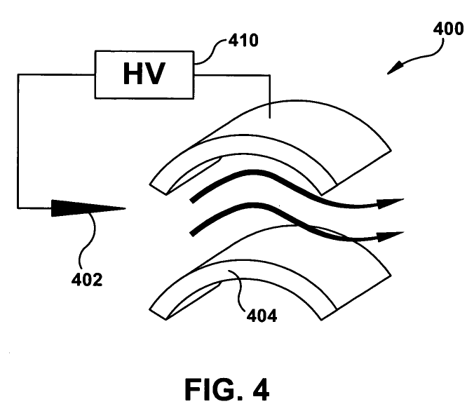

One embodiment 100 is shown in FIG. 1 having a conical emitter electrode 102 in combination with a tubular attracting electrode having a square cross section 104. A high voltage power supply 110 can create a potential difference between the emitter electrode 102 and attracting electrode 104. An air flow is thus created, and flows away from the emitter electrode 102, and through the tube that comprises the attracting electrode 104. FIGS. 2 through 4 illustrate a similar single stage arrangement. In each case, the emitter is conical but the attracting electrode differs. Specifically, FIG. 2 shows a conical attracting electrode 204. FIG. 3 shows a parallel plate-attracting electrode 304. And, FIG. 4 shows a parallel contoured plate-attracting electrode 404.

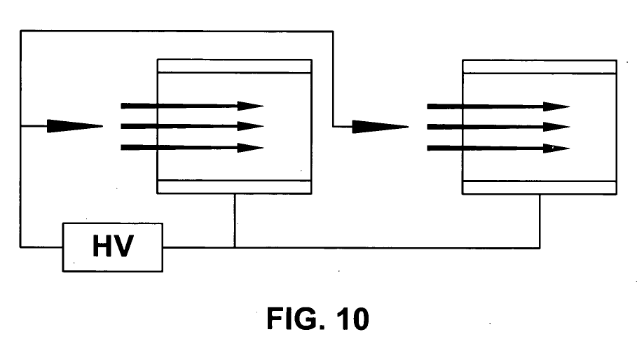

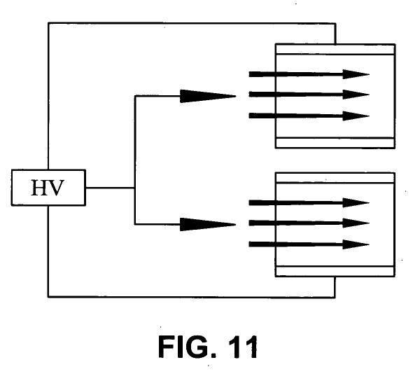

The electrostatic air moving device may be integrated within a fuel cell housing, or attached proximate to an air inlet thereof. Some embodiments may include a plurality of air-moving devices consistent with the foregoing description. When more than one air moving device is present, they can be arranged so that their respective air streams are in series or in parallel. For example, a serial relation is shown schematically in FIG. 10, and a parallel relation is shown schematically in FIG. 11. When a plurality of air moving devices is arranged serially, the output stream of an upstream device serves as the input stream for a downstream device. Any number of air-moving devices can be arranged in a single series. Furthermore, air moving devices can form a plurality of series, and the plurality of series themselves can be arranged in series or in parallel.

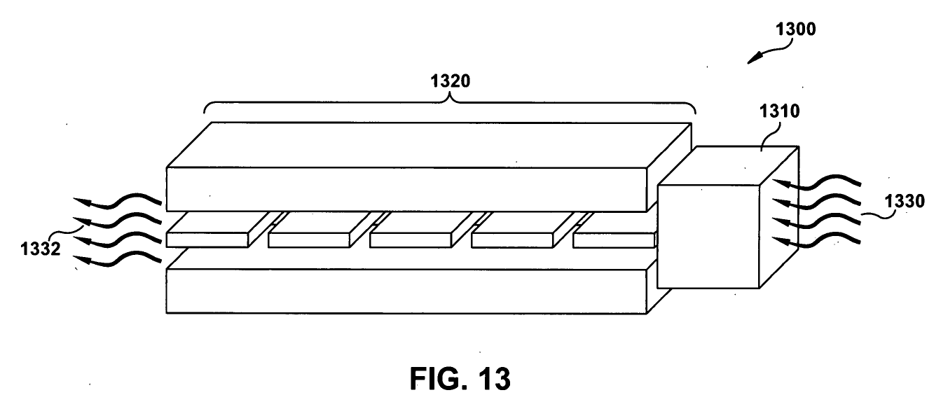

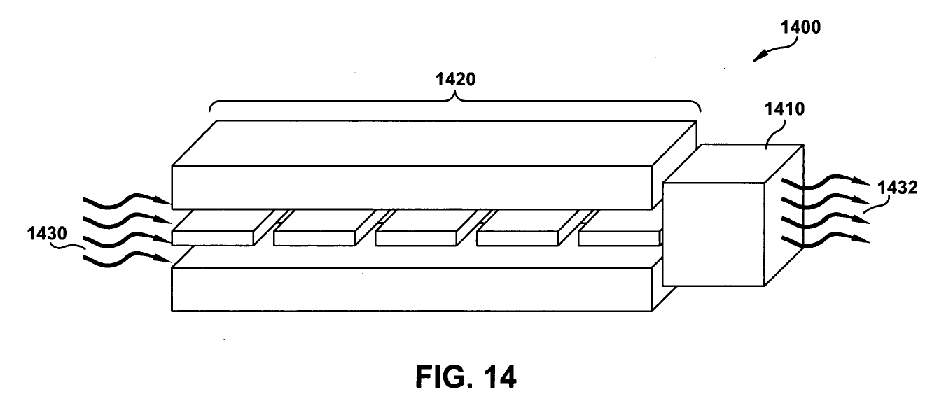

The ESAM(s) can be arranged in a pattern. For example, where the fuel cell housing is rectangular, one ESAM 1310 can push air 1330 into the fuel cell housing 1320 at one end, while a second ESAM can draw air from the housing at an opposing end. Alternatively, a single ESAM can be positioned at one end of the fuel cell housing, and can either push air into the housing, as shown in FIG. 13, or draw air 1432 from the housing 1420, as shown in FIG. 14. The embodiment shown in FIG. 14 may be used in connection with a CO₂-free air supply, and/or an air supply that is free of particulate contaminants. Suitable sources of air in-puts may include, for example, the output air stream of another fuel cell.

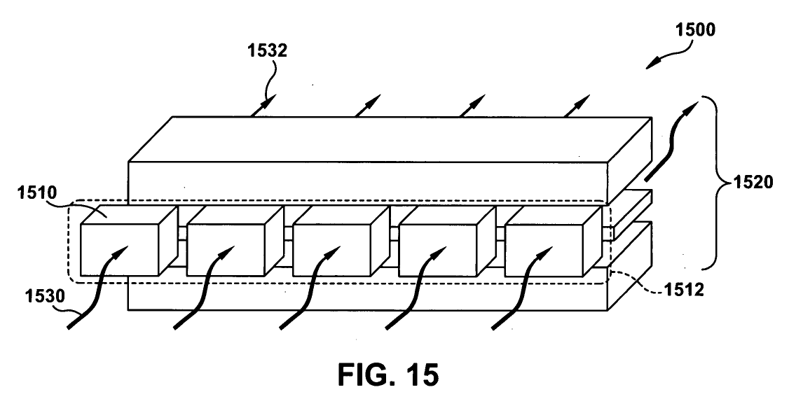

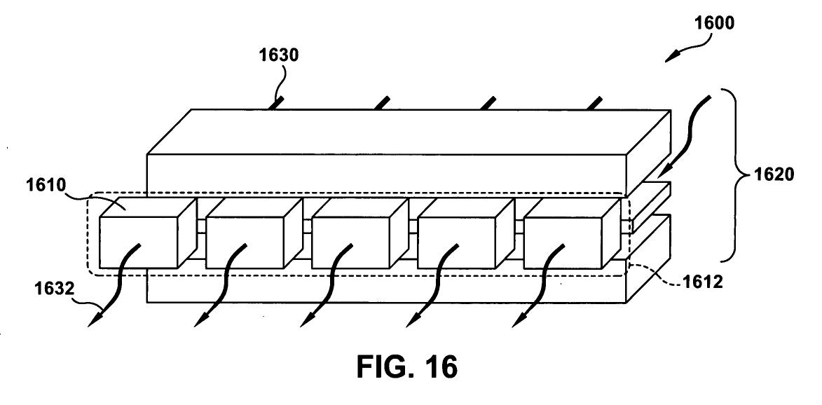

FIG. 15 shows a plurality of ESAM devices 1510 in a parallel array arrangement 1512 where the output air streams 1532 of each ESAM 1510 enters one side of a rectangular fuel cell housing 1520. FIG. 16 shows an alternative arrangement where a plurality 1612 of ESAM devices 1610 are arranged in parallel so that their input air streams 1630 are drawn from the fuel cell housing 1620. The embodiments set forth in both FIGS. 15 and 16 can be combined so that the output air 1532 stream of FIG. 15 serves as the input air stream 1630 of FIG. 16. Furthermore, this pattern may be repeated to form an embodiment comprising a series of fuel cell/ESAM array elements.

The embodiments described herein are examples of compositions, structures, systems and methods having elements corresponding to the elements of the invention recited in the claims. This written description enables one of ordinary skill in the art to make and use embodiments having alternative elements that likewise correspond to the elements of the invention recited in the claims. The scope thus includes compositions, structures, systems and methods that do not differ from the literal language of the claims, and further includes other compositions, structures, systems and methods with insubstantial differences from the literal language of the claims. While only certain features and embodiments have been illustrated and described herein, many modifications and changes may occur to one of ordinary skill in the relevant art. The appended claims are intended to cover all such modifications and changes.

What is claimed is:

1. An apparatus, comprising:
a housing having an interior surface defining a volume, and an air inlet and an air outlet through which the volume is in fluid communication with the ambient environment;
a plurality of electrodes comprising at least one emitter electrode and at least one attracting electrode, and the plurality of electrodes being in fluid communication with the air inlet;
a potential generating device capable of applying a potential across the plurality of electrodes sufficient to cause a corona current between the at least one emitter electrode and the at least one attracting electrode, and wherein the corona current is capable of imparting momentum to surrounding gaseous atoms and molecules, wherein the momentum results in a net fluid flow towards and through the one air inlet; and
a fuel cell cathode disposed within the volume and configured to receive the net fluid flow.

2. The apparatus as defined in claim 1, wherein at least one of the plurality of electrodes comprises one or more metals selected from the group consisting of aluminum, copper, gold, nickel, platinum, and silver.

3. The apparatus as defined in claim 1, wherein at least one of the plurality of electrodes has a geometry selected from the group consisting of cylindrical, azimuthally symmetric, helical, spherical, ellipsoidal, and conical.

4. The apparatus as defined in claim 1, wherein at least one of the plurality of electrodes has a geometry selected from the group consisting of parallel or non parallel flat plates, parallel or non-parallel contoured profile plates, tubular with a circular cross section, tubular with a square cross section, tubular with a polygonal cross section, tubular with a curvilinear cross section, axially converging tubular cross section having linearly varying cross section and opposing open ends, and axially converging tubular cross section having non-linearly varying cross section and opposing open ends.

5. The apparatus as defined in claim 1, wherein the potential generating device is capable of applying a potential that is greater than about 1 kiloVolt.

6. The apparatus as defined in claim 1, wherein the potential generating device is capable of applying a potential that is less than about 50 kilovolt.

7. The apparatus as defined in claim 1, wherein the air inlet is in fluid communication with the air outlet.

8. The apparatus as defined in claim 1, wherein the fuel cell cathode is capable of receiving the net fluid flow, and of using one or more reagent gases in the net fluid flow.

9. The apparatus as defined in claim 1, further comprising a corona current measuring device.

10. The apparatus as defined in claim 1, wherein the corona current is greater than about 0.01 milliAmp.

11. The apparatus as defined in claim 1, wherein the corona current is less than about 0.2 milliAmp.

12. The apparatus as defined in claim 1, wherein the net fluid flow has at least 40 percent fewer particulates than the particulate amount of a corresponding inlet stream prior to exposure to the corona current.

13. The apparatus as defined in claim 1, wherein an effluent gas stream has a velocity in a range of from about 100 feet per minute to about 600 feet per minute.

14. A method, comprising:
applying a potential difference between at least one emitter electrode and at least one attracting electrode sufficient to cause a corona current between the at least one emitter electrode and the at least one attracting electrode and to impart momentum from the corona current to surrounding gaseous atoms and molecules, wherein the momentum results in a net fluid flow towards and through an air inlet and further to a fuel cell cathode that is in fluid communication with the air inlet; and
receiving the net fluid flow at the fuel cell cathode, and the fuel cell cathode using one or more reagent gases in the net fluid flow.

15. The method of claim 14, reducing an amount of particulates in the net fluid flow relative to an amount of particulates in the surround gaseous atoms and molecules.

16. The method of claim 15, wherein the amount of particles in the net fluid flow is in a range of from about 1 percent to about 20 percent lower relative to the surrounding gaseous atoms and molecules.

17. The method of claim 15, wherein the amount of particles in the net fluid flow is in a range of from about 20 percent to about 40 percent lower relative to the surrounding gaseous atoms and molecules.

18. The method of claim 14, wherein the imparted momentum has a velocity that is greater than about 100 feet per minute.

19. The method of claim 14, wherein the imparted momentum has a velocity that is less than about 600 feet per minute.

20. An apparatus, comprising:
a means for containing one or more of the apparatus's component parts;
a means for contacting a gas flow and imparting an electrical charge thereto;
a means for attracting a charged gas flow and imparting a net fluid flow thereto; and
a means for receiving the net fluid flow and converting chemical energy to electrical energy.
